(19) United States
(12) Patent Application Publication
(10) Pub. No.: US 2019/0126570 A1
(43) Pub. Date: May 2, 2019

(54) MANUFACTURING METHOD OF COLOR DECORATIVE PLATE

(71) Applicant: Cozy Industries, Inc., Rowland Heights, CA (US)

(72) Inventor: Phil Chang, West Covina, CA (US)

(21) Appl. No.: 15/797,219

(22) Filed: Oct. 30, 2017

(51) Int. Cl. B29C 70/46; C08K 7/14; C09D 167/02; D06B 19/00

(52) U.S. Cl. CPC B29C 70/467; C08K 7/14; B29K 2067/06; D06B 19/0005; C09D 167/02

(57) ABSTRACT

The present application discloses a manufacturing method of a color decorative plate. Firstly, decorative fiber cloth is immersed and surfacing material is prepared, including steps of: adding various auxiliaries to unsaturated polyester resin; uniformly mixing to form resin paste, wherein the auxiliaries contain an initiator, a mold release agent, an accelerator, a coupling agent, a crosslinking monomer and styrene; uniformly coating the resin paste on the decorative fiber cloth; precuring and drying at 105° C.-130° C. to produce the surfacing material; and compression moulding; feeding a SMC into a mould; and laying the surfacing material on the SMC in the mould for integral compression molding. In the compression molding process, a mold cavity is at an upper part and a mold core is at a lower part. The SMC is used as a structural layer, and the surfacing material is attached to a surface of the structural layer.

### TECHNICAL FIELD OF THE INVENTION

The present application relates to a color decorative plate, and particularly relates to a manufacturing method of a color decorative plate.

### BACKGROUND OF THE INVENTION

In recent years, there are more and more walls which are made by composites material sheet molding compounds (SMCs) and processed with embedded printed color synthetic fiber cloth. Compared with a traditional wall, the above structure mainly has three advantages: 1) matter simplifying and time saving: the wall and corner joint strips are well installed through dry construction without sand and cement, and only adhesives is used; installation time is within one hour instead of one day; a construction period is greatly shortened; 2) leakage prevention: the wall and the corner joint strips are formed by compression molding in one step without splicing gap, thereby fundamentally solving a problem of easy water leakage; 3) better quality: SMC is a material special for an aircraft and a spacecraft and has good characteristics of light weight, smooth and easy to clean surface, excellent insulation, aging prevention, long service life, etc.

However, when pressing a decorative plate by the SMC, a front surface and a back surface of the decorative plate have the same color which is the color of the SMC. The decorative plate has a single color, and a color decorative plate having the same bright color as a wall surface still cannot be manufactured now.

### SUMMARY OF THE INVENTION

The purpose of the present application is to overcome defects in the prior art, so as to provide a manufacturing method of a color decorative plate.

The purpose of the present invention is realized by the following technical solution:

A manufacturing method of a color decorative plate comprises:

1) preparing a decorative fiber cloth;

2) immersing the decorative fiber cloth and preparing surfacing material;

steps of preparing the surfacing material comprise: adding various auxiliaries to unsaturated polyester resin; uniformly mixing to form resin paste, wherein the auxiliaries contain an initiator, a mold release agent, an accelerator, a coupling agent, a crosslinking monomer and styrene; if the mass of the unsaturated polyester resin is designated as 100 parts, then each auxiliary has the following mass parts:

| | |
|---|---|
| the initiator | 1-2 |
| the mold release agent | 3-5 |
| the accelerator | 1-2 |
| the coupling agent | 2-4 |
| the crosslinking monomer | 8-20 |
| the styrene | 3-30 |

uniformly coating the resin paste on the decorative fiber cloth, and precuring and drying at 105° C. to 130° C. to achieve 70%-90% of semi-maturation of the resin paste to produce the surfacing material; and

3) conducting compression molding: firstly feeding sheet molding compound (SMC) into a mould with a feeding area of 75%-95% of an orthographic projection area of a product; and then laying the surfacing material on the SMC in the mould for integral compression molding, wherein in the compression molding process, a mold cavity is at an upper part and a mold core is at a lower part to prevent decorative patterns from deforming because the decorative fiber cloth is stretched due to the flow of the SMC and to avoid wrinkling the decorative fiber cloth; and

after compression molding, the SMC is used as a structural layer, and the surfacing material is attached to a surface of the structural layer.

Further, in the above manufacturing method of the color decorative plate, the mass of the decorative fiber cloth per square meter is 60 g-180 g, and the mass of the resin paste coated on the decorative fiber cloth per square meter is 60 g-120 g.

Further, in the above manufacturing method of the color decorative plate, the decorative fiber cloth is formed by directed or random non-woven fabric fibers.

Further, in the above manufacturing method of the color decorative plate, patterns are printed on the decorative fiber cloth.

Further, in the above manufacturing method of the color decorative plate, the SMC is formed by resin base material and glass fibers dispersed in the resin base material.

Further, in the above manufacturing method of the color decorative plate, the unsaturated polyester resin is isophthalic polyester resin or vinylester resin.

Further, in the above manufacturing method of the color decorative plate, the initiator is tert-butyl peroxybenzoate, or tert-butyl peroxy-2-ethylhexanoate or a compound initiator system of tert-butyl peroxybenzoate and tert-butyl peroxy-2-ethylhexanoate, wherein a mass ratio of tert-butyl peroxybenzoate to tert-butyl peroxy-2-ethylhexanoate is (0.7-0.8): (0.3-0.2).

Further, in the above manufacturing method of the color decorative plate, the accelerator is an accelerator E4.

Further, in the above manufacturing method of the color decorative plate, the mold release agent is stearate or phosphate ester.

Further, in the above manufacturing method of the color decorative plate, the crosslinking monomer is trimethylolpropane triacrylate or ethylene glycol diacrylate.

Further, in the above manufacturing method of the color decorative plate, the coupling agent is a KH-570 silane coupling agent.

Compared with the prior art, the present application has apparent advantages and beneficial effects specifically reflected as follows:

\textcircled{1} The manufacturing method of the color decorative plate in the present application can be used for producing the color decorative plate with good apparent quality for use in a wall by means of the compression molding procedure only; procedures are saved, the cost is low and process control is relatively simple.

\textcircled{2} By adding the crosslinking monomer, when the decorative fiber cloth and the SMC are integrally pressed and molded, the crosslinking monomer reacts with the unsaturated polyester resin in the SMC to enhance the firm degree of bonding. Meanwhile, through the addition of the crosslinking monomer, the decorative fibers have higher surface brightness and the product has a good surface effect.

\textcircled{3} Through the addition of the initiator and the accelerator in a reasonable proportion, the semi-maturation of the decorative fibers is controlled within a required range, thereby benefiting not only storage of the immersed decorative fibers, but also integral forming of the immersed decorative fibers and the SMC at the time of using the immersed decorative fibers.

\textcircled{4} Through the addition of the accelerator, the semi-maturation of the immersed adhesive layer of the decorative fiber cloth is increased.

\textcircled{5} The decorative fiber cloth formed by the directed or random non-woven fabric fibers is adopted. The decorative fiber cloth has the characteristics of moisture resistance, ventilation, flexibility, light weight, no combustion supporting, no toxin and stimulation, rich colors, recycling, etc.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a flow chart of a manufacturing method of a color decorative plate.

FIG. 2A is across-sectional view of a decorative fiber cloth.

FIG. 2B is a view showing a composition of resin paste.

FIGS. 2C-2D are cross-sectional views of the color decorative plate showing the manufacturing process thereof.

FIG. 3A is across-sectional view of a PE film.

FIG. 3B is a view showing a composition of paste material.

FIGS. 3C-3D are cross-sectional views of a sheet molding compound showing the manufacturing process thereof.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

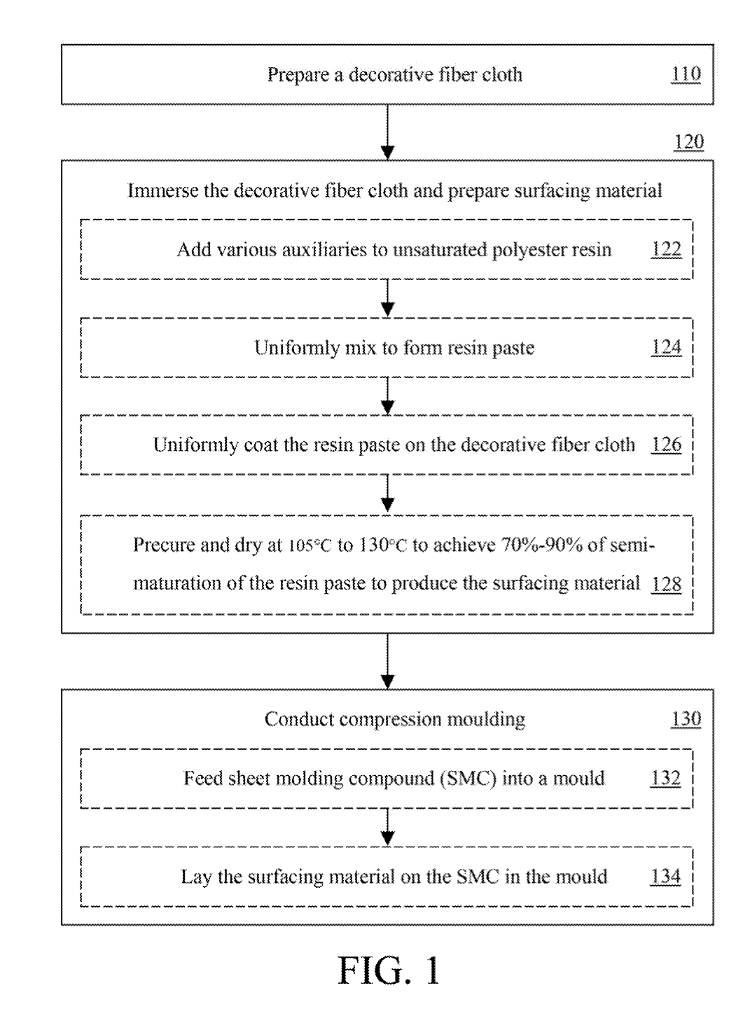

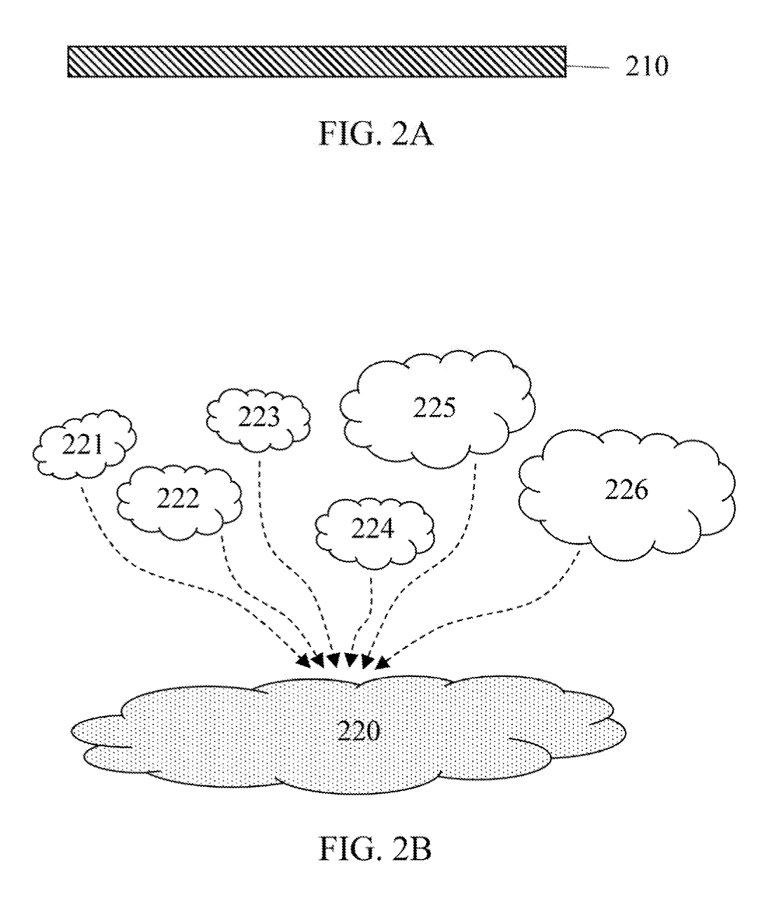

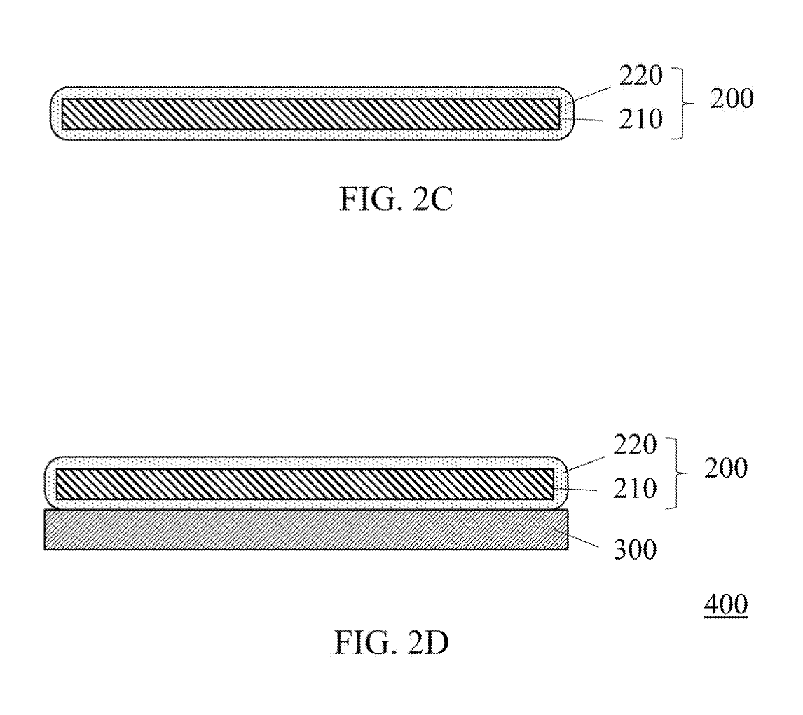

FIG. 1 is a flow chart of a manufacturing method of a color decorative plate 400. FIG. 2A is across-sectional view of a decorative fiber cloth 210. FIG. 2B is a view showing a composition of resin paste 220. FIGS. 2C-2D are cross-sectional views of the color decorative plate 400 showing the manufacturing process thereof.

Referring to FIGS. 1-2D, a specific manufacturing process of the color decorative plate 400 is as follows:

1) as shown in step 110, preparing a decorative fiber cloth 210, wherein the decorative fiber cloth 210 is formed by directed or random non-woven fabric fibers, and patterns of different colors are printed on the decorative fiber cloth 210;

2) as shown in step 120, immersing the decorative fiber cloth 210 and preparing surfacing material 200;

steps of preparing the surfacing material 200 comprise: adding various auxiliaries to unsaturated polyester resin as shown in step 122; uniformly mixing to form resin paste 220 as shown in step 124, wherein the auxiliaries contain an initiator 221, a mold release agent 222, an accelerator 223, a coupling agent 224, a crosslinking monomer 225 and styrene 226; if the mass of the unsaturated polyester resin is designated as 100 parts, then each auxiliary has the following mass parts:

| | |
|---|---|
| the initiator 221 | 1-2 |
| the mold release agent 222 | 3-5 |
| the accelerator 223 | 1-2 |
| the coupling agent 224 | 2-4 |
| the crosslinking monomer 225 | 8-20 |
| the styrene 226 | 3-30 |

uniformly coating the resin paste 220 on the decorative fiber cloth 210 as shown in step 126, wherein the mass of the decorative fiber cloth 210 per square meter is 60 g-180 g, and the mass of the resin paste 220 coated on the decorative fiber cloth 210 per square meter is 60 g-120 g; and precuring and drying at 105° C. to 130° C. to achieve 70%-90% of semi-maturation of the resin paste 210 to produce the surfacing material 200 as shown in step 128;

3) as shown in step 130, conducting compression molding: firstly feeding sheet molding compound (SMC) 300 into a mould as shown in step 132, wherein the SMC 300 is formed by resin base material and glass fibers dispersed in the resin base material and a feeding area is 75%-95% of an orthographic projection area of a product; and then laying the surfacing material 200 on the SMC 300 in the mould for integral compression molding as shown in step 134, wherein in the compression molding process, a mold cavity is at an upper part and a mold core is at a lower part to prevent decorative patterns from deforming because the decorative fiber cloth 210 is stretched due to the flow of the SMC 300 and avoid wrinkling the decorative fiber cloth 210; and

after compression molding, the SMC 300 is used as a structural layer, and the surfacing material 200 is attached to a surface of the structural layer.

The unsaturated polyester resin is isophthalic polyester resin or vinylester resin. The initiator 221 is tert-butyl peroxybenzoate, or tert-butyl peroxy-2-ethylhexanoate or a compound initiator system of tert-butyl peroxybenzoate and tert-butyl peroxy-2-ethylhexanoate, and a mass ratio of tert-butyl peroxybenzoate to tert-butyl peroxy-2-ethylhexanoate is (0.7-0.8): (0.3-0.2). The accelerator 223 is an accelerator E4. The mold release agent 222 is stearate or phosphate ester. The crosslinking monomer 225 is trimethylolpropane triacrylate or ethylene glycol diacrylate. The coupling agent 224 is a KH-570 silane coupling agent.

### Embodiment 1

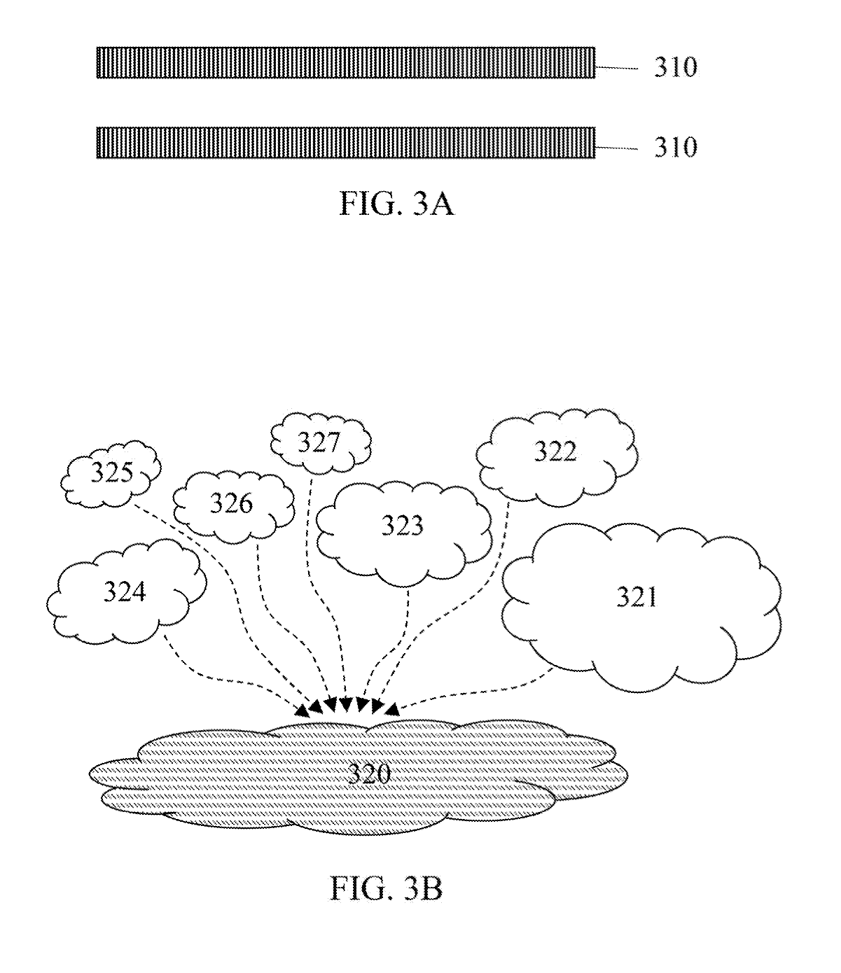

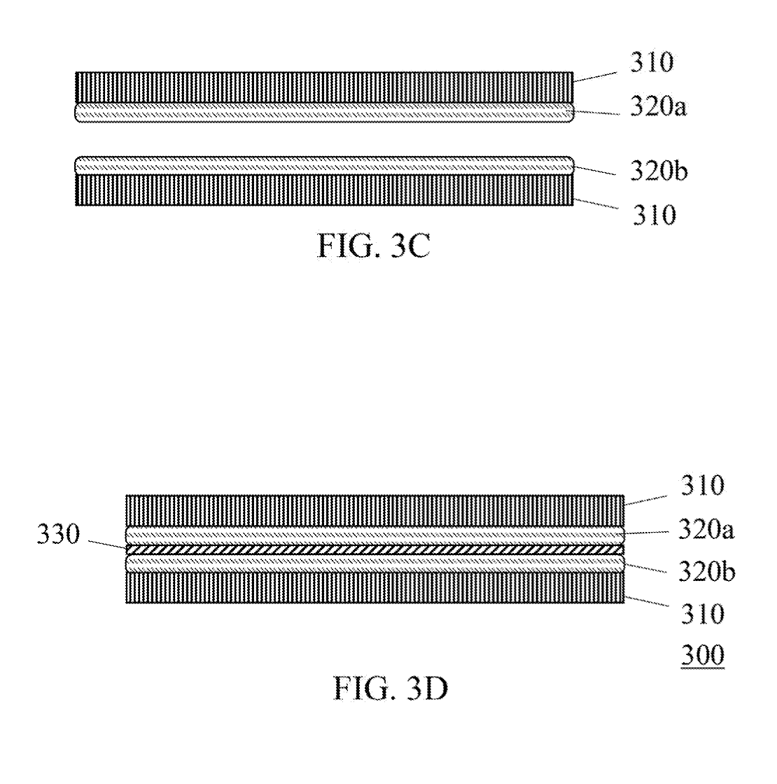

FIG. 3A is a cross-sectional view of a PE film. FIG. 3B is a view showing a composition of paste material. FIGS. 3C-3D are cross-sectional views of a SMC showing the manufacturing process thereof.

Referring to FIGS. 1-3D, the color decorative plate 400 is prepared according to the following steps:

1) resin paste 220 is prepared according to the following formulation (mass parts):

| | | |
|---|---|---|
| resin base material: unsaturated polyester resin | 100 | parts |
| initiator 221: tert-butyl peroxybenzoate (TBPB) | 1 | part |
| mold release agent 222: phosphate ester | 3 | parts |
| accelerator 223: E4 | 2 | parts |
| coupling agent 224: silane coupling agent KH570 | 2 | parts |
| crosslinking monomer 225: trimethylolpropane triacrylate | 8 | parts |

After the above raw materials are uniformly mixed to produce the resin paste 220, 10 parts of styrene 226 are added to adjust viscosity to appropriately dilute the resin paste 220.

The above resin paste 220 is uniformly coated on the decorative fiber cloth 210 with color texture; and the mass ratio of the resin paste 220 to the decorative fiber cloth 210 is about 1:1. The decorative fiber cloth 210 coated with the resin paste 220 is fed into a drying tunnel of about 135° C. for precuring to ensure the semi-maturation achieves about 80% to produce decorative fiber material with a color surface for the compression molding of the decorative plate;

2) SMC 300 is prepared according to the following formulation (mass parts):

| | | |
|---|---|---|
| unsaturated polyester resin 321: isophthalic polyester resin | 80 | parts; |
| low shrinkage additive 322: polymethylmethacrylate | 20 | parts; |
| inorganic filler 323: calcium carbonate | 30 | parts; |
| chopped glass fiber 324: | 20 | parts; |
| initiator 325: tert-butyl peroxybenzoate (TBPB) | 1 | part; |
| mold release agent 326: zinc stearate | 4 | parts; |
| thickener 327: magnesia | 1.2 | parts; |

The above raw materials are uniformly mixed to produce paste material 320.

The above paste material 320 is uniformly coated on an upper PE film 310 and a lower PE film 310 through a scraper, glass fibers 330 are cut by adjusting a cutter, and length and content of the glass fibers 300 are controlled; an upper paste material layer 320a and a lower paste material layer 320b are pasted oppositely, the glass fibers 330 are placed between two paste material layers 320a/320b to form a sheet material coated with the PE films 310 on an upper part and a lower part; the sheet material is extruded through a compactor to fully immerse the sheet material to form the sheet material; then the sheet material is coiled;

the coiled sheet material is delivered to a thickening chamber for thickening; the temperature of the thickening chamber is 45° C.; the thickening time is 24 hours; and the SMC 300 is obtained.

3) compression molding is conducted: feeding the SMC 300 into a mould with a feeding area of 75%-95% of an orthographic projection area of a product, and laying the surfacing material 200 on the SMC 300 in the mould for integral compression molding, wherein in the compression molding process, a mold cavity is at an upper part and a mold core is at a lower part, temperatures of the mold cavity and the mold core of the mould are respectively 145° C. and 138° C., compression molding pressure is selected as 40 kg/m², molding time is 125 seconds and the thickness of a final product is 2 mm; trimming after completing compression molding; and finishing flash and burr around the product.

The patterns on the surface of the obtained finished product have high clarity and brightness.

### Embodiment 2

1) resin paste 220 is prepared according to the following formulation (mass parts):

| | | |
|---|---|---|
| resin base material: vinylester resin | 100 | parts |
| initiator 221: tert-butyl peroxybenzoate (TBPB) | 2 | parts |
| mold release agent 222: phosphate ester | 5 | parts |
| accelerator 223: E4 | 1 | part |
| coupling agent 224: silane coupling agent KH570 | 2 | parts |
| crosslinking monomer 225: trimethylolpropane triacrylate | 20 | parts |

After the above raw materials are uniformly mixed to produce the resin paste 220, 18 parts of styrene 226 are added to adjust viscosity to appropriately dilute the resin paste 220.

The above resin paste 220 is uniformly coated on the decorative fiber cloth 210 with color texture; and the mass ratio of the resin paste 220 to the decorative fiber cloth 210 is about 1:1. The decorative fiber cloth 210 coated with the resin paste 220 is fed into a drying tunnel of about 135° C. for precuring to ensure the semi-maturation achieves about 80% to produce decorative fiber material with a color surface for the compression molding of the decorative plate;

2) SMC 300 is prepared according to the following formulation (mass parts):

| | | |
|---|---|---|
| unsaturated polyester resin 321: isophthalic polyester resin | 80 | parts; |
| low shrinkage additive 322: polymethylmethacrylate | 20 | parts; |
| inorganic filler 323: calcium carbonate | 30 | parts; |
| chopped glass fiber 324: | 20 | parts; |
| initiator 325: tert-butyl peroxybenzoate (TBPB) | 1 | part; |
| mold release agent 326: zinc stearate | 4 | parts; |
| thickener 327: magnesia | 1.2 | parts; |

The above raw materials are uniformly mixed to produce paste material 320.

The above paste material 320 is uniformly coated on an upper PE film 310 and a lower PE film 310 through a scraper; glass fibers 330 are cut by adjusting a cutter, and length and content of the glass fibers 300 are controlled; an upper paste material layer 320a and a lower paste material layer 320b are pasted oppositely; the glass fibers 330 are placed between two paste material layers 320a/320b to form a sheet material coated with the PE films 310 on an upper part and a lower part; the sheet material is extruded through a compactor to fully immerse the sheet material to form the sheet material; then the sheet material is coiled;

the coiled sheet material is delivered to a thickening chamber for thickening; the temperature of the thickening chamber is 45° C.; the thickening time is 24 hours; and the SMC 300 is obtained.

3) compression molding is conducted: feeding the SMC 300 into a mould with a feeding area of 75%-95% of an orthographic projection area of a product; and laying the surfacing material 200 on the SMC 300 in the mould for integral compression molding, wherein in the compression molding process, a mold cavity is at an upper part and a mold core is at a lower part, temperatures of the mold cavity and the mold core of the mould are respectively 145° C. and 138° C., compression molding pressure is selected as 40 kg/m², molding time is 125 seconds and the thickness of a final product is 2 mm; trimming after completing compression molding; and finishing flash and burr around the product.

The patterns on the surface of the obtained finished product have high clarity and brightness.

### Embodiment 3

1) resin paste 220 is prepared according to the following formulation (mass parts):

| | | |
|---|---|---|
| resin base material: vinylester resin | 100 | parts |
| initiator 221: tert-butyl peroxybenzoate (TBPB) | 1.5 | parts |
| mold release agent 222: phosphate ester | 3.5 | parts |
| accelerator 223: E4 | 1.5 | parts |
| coupling agent 224: silane coupling agent KH570 | 2 | parts |
| crosslinking monomer 225: trimethylolpropane triacrylate | 20 | parts |

After the above raw materials are uniformly mixed to produce the resin paste 220, 15 parts of styrene 226 are added to adjust viscosity to appropriately dilute the resin paste 220.

The above resin paste 220 is uniformly coated on the decorative fiber cloth 210 with color texture; and the mass ratio of the resin paste 220 to the decorative fiber cloth 210 is about 1:1. The decorative fiber cloth 210 coated with the resin paste 220 is fed into a drying tunnel of about 135° C. for precuring to ensure the semi-maturation achieves about 80% to produce decorative fiber material with a color surface for the compression molding of the decorative plate;

2) SMC 300 is prepared according to the following formulation (mass parts):

| | | |
|---|---|---|
| unsaturated polyester resin 321: isophthalic polyester resin | 80 | parts; |
| low shrinkage additive 322: polymethylmethacrylate | 20 | parts; |
| inorganic filler 323: calcium carbonate | 30 | parts; |
| chopped glass fiber 324: | 20 | parts; |
| initiator 325: tert-butyl peroxybenzoate (TBPB) | 1 | part; |
| mold release agent 326: zinc stearate | 4 | parts; |
| thickener 327: magnesia | 1.2 | parts; |

The above raw materials are uniformly mixed to produce paste material 320.

The above paste material 320 is uniformly coated on an upper PE film 310 and a lower PE film 310 through a scraper, glass fibers 330 are cut by adjusting a cutter, and length and content of the glass fibers 330 are controlled; an upper paste material layer 320a and a lower paste material layer 320b are pasted oppositely; the glass fibers 330 are placed between two paste material layers 320a/320b to form a sheet material coated with the PE films 310 on an upper part and a lower part; the sheet material is extruded through a compactor to fully immerse the sheet material to form the sheet material; then the sheet material is coiled;

the coiled sheet material is delivered to a thickening chamber for thickening; the temperature of the thickening chamber is 45° C.; the thickening time is 24 hours; and the SMC 300 is obtained.

3) compression molding is conducted: feeding the SMC 300 into a mould with a feeding area of 75%-95% of an orthographic projection area of a product; and laying the surfacing material 200 on the SMC 300 in the mould for integral compression molding, wherein in the compression molding process, a mold cavity is at an upper part and a mold core is at a lower part, temperatures of the mold cavity and the mold core of the mould are respectively 145° C. and 138° C., compression molding pressure is selected as 40 kg/m2, molding time is 125 seconds and the thickness of a final product is 2 mm; trimming after completing compression molding; and finishing flash and burr around the product.

The patterns on the surface of the obtained finished product have high clarity and brightness.

Test results of the above embodiments are shown in the following table:

| | Embodiment 1 | Embodiment 2 | Embodiment 3 |
|---|---|---|---|
| Stripping | After immersing for 24 hours | After immersing for 24 hours | After immersing for 24 hours |
| performance | in warm water of 80° C., | in warm water of 80° C., | in warm water of 80° C., |
| | stripping is conducted while | stripping is conducted while | stripping is conducted while |
| | hot and the surfacing material | hot and the surfacing material | hot and the surfacing material |
| | is not separated from the | is not separated from the | is not separated from the |
| | structural layer | structural layer | structural layer |
| Acid and alkali | After coating a test surface | After coating a test surface | After coating a test surface |
| resistance | for 1 hour with HCl solution | for 1 hour with HCl solution | for 1 hour with HCl solution |
| | of a 3% concentration and | of a 3% concentration and | of a 3% concentration and |
| | cleaning, no crack and | cleaning, no crack and | cleaning, no crack and |
| | inflation exist on the surface, | inflation exist on the surface, | inflation exist on the surface, |
| | barcol hardness is 48 and a | barcol hardness is 48 and a | barcol hardness is 48 and a |
| | color difference ΔE is 1.0 | color difference ΔE is 1.1 | color difference ΔE is 0.9 |
| Boiling | After immersing for 24 hours | After immersing for 24 hours | After immersing for 24 hours |
| resistance | in warm water of 80° C., no | in warm water of 80° C., no | in warm water of 80° C., no |
| | crack and bump exist | crack and bump exist | crack and bump exist |
| Pollution | After mixing petrolatum and | After mixing petrolatum and | After mixing petrolatum and |
| resistance | carbon black (9:1), coating | carbon black (9:1), coating | carbon black (9:1), coating |
| | for 30 minutes and cleaning, | for 30 minutes and cleaning, | for 30 minutes and cleaning, |
| | a recovery rate is determined | a recovery rate is determined | a recovery rate is determined |
| | as 96 and a color difference | as 98 and a color difference | as 98 and a color difference |
| | ΔE is determined as 0.8 | ΔE is determined as 0.7 | ΔE is determined as 0.6 |
| Glossiness | 88 | 95 | 95 |
| (GU) | | | |

By adding the crosslinking monomer 225, when the decorative fiber cloth 210 and the SMC 300 are integrally pressed and molded, the crosslinking monomer 225 reacts with the unsaturated polyester resin in the SMC 300 to enhance the firm degree of bonding. Meanwhile, through the addition of the crosslinking monomer 225, the decorative fibers have higher surface brightness and the product has a good surface effect.

8-20 parts of crosslinking monomer 225 are added. If less than 8 parts of crosslinking monomer 225 are added, the obtained product has poor surface brightness and low bonding strength. If more than 20 parts of crosslinking monomer 225 are added, the obtained surfacing material 200 has excessively high hardness and surfacing crack is easy to occur in the compression moulding process, causing bad phenomena such as surface crack of the product, etc.

Through the addition of the initiator 221 and the accelerator 223 in a reasonable proportion, the semi-maturation of the decorative fibers is controlled within a required range, thereby benefiting not only storage of the immersed decorative fibers, but also integral forming of the immersed decorative fibers and the SMC 300 at the time of using the immersed decorative fibers.

The E4 accelerator 223 is selected as the accelerator 223, and is a novel accelerator 223 prepared by using cobalt iso-octoate and styrene as major raw materials. The accelerator 223 has high purity, good color and luster and high cobalt content, and is widely suitable for various glass fiber reinforced polyester products, gel coat, artificial marble, etc. Through the addition of the accelerator 223, the semi-maturation of an immersed adhesive layer of the decorative fiber cloth 210 can be increased. Because the density of the decorative fiber cloth 210 is not as good as decorative paper, if the semi-maturation is insufficient, when integral compression molding with the SMC 300 is conducted, the SMC 300 on a back surface may pass through the decorative fiber cloth 210 to reach the surface of the decorative plate, thereby covering the surface texture of the decorative fiber cloth 210 to generate an unqualified product.

The decorative fiber cloth 210 formed by the directed or random non-woven fabric fibers is adopted. Since the decorative fiber cloth 210 is formed by the fibers, the decorative fiber cloth 210 is called fiber cloth. The fiber cloth is a new generation of environmental protection material and has the characteristics of moisture resistance, ventilation, flexibility, light weight, no combustion supporting, no toxin and stimulation, rich colors, recycling, etc. If polyester granules are mainly used as raw materials, the decorative fiber cloth 210 is produced through a continuous one-step method of high temperature melting, spinning, steel laying and hot-rolling coiling. The decorative fiber cloth 210 is called cloth due to an appearance of cloth and some properties.

Non-woven fabric is a kind of non-weaving cloth which is non-braided fabric formed by enabling fibers to form a net through an air flow or a machine directly using polymer slices, short fibers or filaments, then reinforcing through spunlace, needling or hot rolling and finally after-finishing. The non-woven fabric is a novel fiber product with a soft, ventilating and planar structure, has the advantages of no generation of fiber flock, toughness, durability and silky softness, and is one of reinforcing materials. The non-woven fabric also brings a cottony feeling, is made of 100% fibers and has good porosity and air permeability. No toxin and stimulation: the product is produced by food grade ingredients that conform to FDA, is free of other chemical components, and has stable performance, no toxin and no peculiar smell. Bacteria and chemicals resistance: the product belongs to chemically passive substances, has no damage by worms and can isolate erosion by bacteria and insects in liquid. Bacteria resistance and alkali corrosion resistance ensure that the finished product is not affected in strength due to erosion. The product has water-repellent property, does not get mildew, can isolate erosion by bacteria and insects in liquid, has no damage by mildew, and has good physical property. The product is formed by spinning high polymers such as polyester, etc., directly laying into a net and conducting thermal bonding. The product has better strength than a general chopped fiber product. The strength is nondirectional and longitudinal strength and transverse strength are close.

Specifically, the color decorative plate is suitable for being used in humid places such as bathroom. In addition, the color decorative plate also can be utilized for other furniture which can provide similar effects such as for bathtub walls. However, the present application is not limited thereto, the color decorative plate of present application can be used for any kind of walls or furniture as long as needed.

In conclusion, the manufacturing method of the color decorative plate in the present application can be used for producing the color decorative plate with good apparent quality by the compression molding procedure.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A manufacturing method of a color decorative plate, comprising:
1) preparing a decorative fiber cloth;
2) immersing the decorative fiber cloth and preparing surfacing material;
steps of preparing the surfacing material comprise: adding various auxiliaries to unsaturated polyester resin; uniformly mixing to form resin paste, wherein the auxiliaries contain an initiator, a mold release agent, an accelerator, a coupling agent, a crosslinking monomer and styrene; if the mass of the saturated polyester resin is designated as 100 parts, then each auxiliary has the following mass parts:

| | |
|---|---|
| the initiator | 1-2 |
| the mold release agent | 3-5 |
| the accelerator | 1-2 |
| the coupling agent | 2-4 |
| the crosslinking monomer | 8-20 |
| the styrene | 3-30 |

uniformly coating the resin paste on the decorative fiber cloth; and precuring and drying at 105° C. to 130° C. to achieve 70%-90% of semi-maturation of the resin paste to produce the surfacing material; and
3) conducting compression molding: firstly feeding sheet molding compound (SMC) into a mould with a feeding area of 75%-95% of an orthographic projection area of a product; and laying the surfacing material on the SMC in the mould for integral compression moulding, wherein in the compression molding process, a mold cavity is at an upper part and a mold core is at a lower part to prevent decorative patterns from deforming because the decorative fiber cloth is stretched due to flow of the SMC and to avoid wrinkling the decorative fiber cloth;
the SMC is used as a structural layer, and the surfacing material is attached to a surface of the structural layer.

2. The manufacturing method of the color decorative plate as claimed in claim 1, wherein the mass of the decorative fiber cloth per square meter is 60 g-180 g, and the mass of the resin paste coated on the decorative fiber cloth per square meter is 60 g-120 g.

3. The manufacturing method of the color decorative plate as claimed in claim 1, wherein the decorative fiber cloth is formed by directed or random non-woven fabric fibers.

4. The manufacturing method of the color decorative plate as claimed in claim 1, wherein patterns are printed on the decorative fiber cloth.

5. The manufacturing method of the color decorative plate as claimed in claim 1, wherein the SMC is formed by resin base material and glass fibers dispersed in the resin base material.

6. The manufacturing method of the color decorative plate as claimed in claim 1, wherein the unsaturated polyester resin is isophthalic polyester resin or vinylester resin.

7. The manufacturing method of the color decorative plate as claimed in claim 1, wherein the initiator is tert-butyl peroxybenzoate, tert-butyl peroxy-2-ethylhexanoate, or a compound initiator system of tert-butyl peroxybenzoate and tert-butyl peroxy-2-ethylhexanoate, wherein a mass ratio of tert-butyl peroxybenzoate to tert-butyl peroxy-2-ethylhexanoate is (0.7-0.8):(0.3-0.2).

8. The manufacturing method of the color decorative plate as claimed in claim 1, wherein the accelerator is an accelerator E4.

9. The manufacturing method of the color decorative plate as claimed in claim 1, wherein the mold release agent is stearate or phosphate ester.

10. The manufacturing method of the color decorative plate as claimed in claim 1, wherein the crosslinking monomer is trimethylolpropane triacrylate or ethylene glycol diacrylate.

11. The manufacturing method of the color decorative plate as claimed in claim 1, wherein the coupling agent is a KH-570 silane coupling agent.
